(19) United States
(12) Patent Application Publication
(10) Pub. No.: US 2017/0200400 A1
(43) Pub. Date: Jul. 13, 2017

(54) FACILITATION OF CARDHOLDER PLACEMENT ON MOBILE DEVICES

(71) Applicant: Samuel Shea Taylor, Atlanta, GA (US)

(72) Inventor: Samuel Shea Taylor, Atlanta, GA (US)

(21) Appl. No.: 15/402,181

(22) Filed: Jan. 9, 2017

Related U.S. Application Data
(60) Provisional application No. 62/276,946, filed on Jan. 10, 2016.

(51) Int. Cl. G09F 1/10

(52) U.S. Cl. CPC G09F 1/10

(57) ABSTRACT

This disclosure relates generally to display of cardholders. Cardholders can be used in a variety of ways in conjunction with mobile devices. Leveraging cardholders with mobile devices can allow for greater visibility of cards and additional marketing.

### CROSS-REFERENCE TO RELATED APPLICATION

The subject patent application claims priority to U.S. Provisional Patent Application No. 62/276946, filed Jan. 10, 2016, and entitled “FACILITATION OF CARDHOLDER PLACEMENT ON MOBILE DEVICES.” The entirety of the aforementioned application is hereby incorporated by reference herein.

### TECHNICAL FIELD

This disclosure relates generally to the use of cardholders. More specifically, this disclosure relates to the use of cardholders in conjunction with mobile devices.

### BACKGROUND

Cards are traditionally used for exchanging relevant personal information, such as contact information, in a seamless manner. Many types of cards exist including, but not limited to, business cards, identification cards, credit cards, etc. For example, business cards can contain information about a company, person, and/or contact information. Cardholders can be used so that business cards do not become wrinkled or smudged. Cardholders can also protect the integrity of the card and allow for ease of access and exchange of information.

The above-described background relating to business holders is merely intended to provide a contextual overview of some current technology, and is not intended to be exhaustive. Other context regarding the state of the art may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the purpose of this summary is to present some concepts related to some exemplary non-limiting embodiments in simplified form as a prelude to more detailed descriptions of the various embodiments that follow in the disclosure.

Described herein are systems, articles of manufacture, and other embodiments or implementations that can facilitate the use of cardholders in conjunction with mobile devices and mobile device covers. Cardholders can be used for a variety of functions. The typical cardholder is designed to be placed in a pocket or a purse. The cardholder owner only brings the cardholder out once he/she has established that he/she would actively like to give his/her card to someone else. However, the potential of a cardholder can be maximized by allowing the cardholder to showcase cards even when the owner is not actively looking to distribute his/her card.

Cardholders can come in a variety of sizes (length, width, thickness, etc.) to accommodate holding one or more cards. Since mobile devices such as laptops, wireless phones, tablets, etc. are prevalent, integrating a cardholder with a mobile device can allow for additional exposure of cards that are within the cardholder. For instance, in one embodiment, a cardholder can attach to a laptop screen. A fitted flange or clip can overlap the top of the edge of the laptop screen allowing the business card holder to remain stationary. The flange can also be mechanically adjustable or made from a flexible or malleable material to facilitate a flush fitting of the business card holder with a variety of different sized mobile devices. The flange can be placed over the top or side edges of the laptop screen with enough clearance so that the flange does not overlap the physical laptop screen itself. For instance a right lip, a bottom lip, and a left lip can be used to facilitate holding of the card. A top lip, a left lip, and a bottom lip can facilitate the holding of the card; and a top lip, a right lip, and a bottom lip can facilitate the holding of the card.

In another embodiment, the cardholder can be applied to the mobile device by way of an adhesive. The adhesive can be a magnet, permanent adhesive, a removable adhesive, a temperature responsive adhesive, etc. The cardholder lips can also be shortened, widened, ascend, descend, and/or thickened to provide support for the cards. Consequently, the lips can be formed to provide additional space for information and/or marketing. For instance, the lips can be formed to provide enough space for a company logo, a business name, a website etc. on the cardholder itself, separate from the actual card.

In yet another embodiment, the cardholder can be integrated into a mobile device cover. For example, the cardholder can be integrated into a laptop cover allowing the cards to be visible to others while the laptop is in use. The laptop cover can comprise injection molded lips to facilitate the display of cards. The laptop cover lips can comprise a right lip, a bottom lip, and a left lip; a top lip, a left lip, and a bottom lip; and a top lip, a right lip, and a bottom lip. The laptop cover can be made out of any material including, but not limited to, metal, plastic, wood, etc.

The cardholder can also be integrated with a clip/prong, where the cardholder, the clip/prong, and a rotatable grommet form one piece. The rotatable grommet can allow for a 360 degree rotation of the cardholder. The rotatable grommet can also interact with an interlocking mechanism so that the business card holder can be interlocked at varying degrees within the 360 degree rotation. For instance, the interlocking mechanism can be used to facilitate visibility of cards at a 90 degree angle from an original location. However, in another embodiment, the cardholder can also be detachable from the rotatable grommet to allow for interchangeability of cardholders. For instance, a longer cardholder may be desired for longer cards, therefore a user may want to interchange a shorter cardholder with the longer cardholder. The user may also want to interchange a vertical oriented cardholder for a horizontal oriented cardholder based on the type and design of card that the user wishes to display.

In yet another embodiment, the cardholder can comprise a multiple flanges. For instance, the cardholder can have a top flange and a side flange, which can allow the cardholder to be flush-mounted to a laptop screen corner. Different variations, such as a top flange and a left flange or a top flange and a right flange can be utilized. A side (left/right) flange can also be used with a bottom lip to facilitate card visibility. The top flange and side flange can also be used to form the lip for which the cards can be placed.

According to one embodiment, described herein is an apparatus for facilitating the display of cards within a cardholder. The apparatus can have a flange which is so dimensioned as to fasten the apparatus to the mobile device. The apparatus can have a planar surface wherein a rear surface of the planar surface is adjacent to the mobile device, and a front surface of the planar surface comprises lips for holding a card. Various lips in combination can form the actual cardholder portion itself. The lips can form various recesses between the front surface of the planar surface of the cardholder device and the lip itself. Thus, the recesses can accommodate the cards. For example, the wider the recesses, the more cards can be placed into the cardholder.

According to another embodiment, described herein is an apparatus for facilitating the display of cards within a cardholder. A flange on the apparatus can be so dimensioned as to fasten to a mobile device and comprise a rotating mechanism. The apparatus can have a planar surface, connected to the rotating mechanism, wherein a front surface of the planar surface can comprise a lip for holding a card.

According to yet another embodiment, described herein is an apparatus for facilitating the display of cards, which is integrated into a mobile device cover. The mobile device cover can comprise a planar surface and the planar surface can comprise a left lip, a bottom lip, and a right lip, wherein the left lip, the bottom lip, and the right lip are so dimensioned to hold a card.

These and other embodiments or implementations are described in more detail below with reference to the drawings.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates a cardholder device with a flange for overlapping a laptop screen perimeter in one or more embodiments.

FIG. 2 illustrates a cardholder device utilizing an adhesive to stick to the laptop screen rear in one or more embodiments.

FIG. 3 illustrates a laptop cover comprising a built-in cardholder in one or more embodiments.

FIG. 4 illustrates a rotatable cardholder device comprising a clip in one or more embodiments.

FIG. 5 illustrates a flange-based cardholder device comprising a right lip and a bottom lip in one or more embodiments.

FIG. 6 illustrates a flange-based cardholder device comprising a top lip, a right lip, and a bottom lip in one or more embodiments.

### DETAILED DESCRIPTION

In the following description, numerous specific details are set forth to provide a thorough understanding of various embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in one or more embodiments.

The words “exemplary” and/or “demonstrative” are used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As an overview of the various embodiments presented herein, to correct for the above identified deficiencies and other drawbacks of business cardholders.

For simplicity of explanation, the methods (or algorithms) are depicted and described as a series of acts. It is to be understood and appreciated that the various embodiments are not limited by the acts illustrated and/or by the order of acts. For example, acts can occur in various orders and/or concurrently, and with other acts not presented or described herein. Furthermore, not all illustrated acts may be required to implement the methods. In addition, the methods could alternatively be represented as a series of interrelated states via a state diagram or events. Additionally, the methods described hereafter are capable of being stored on an article of manufacture (e.g., a computer readable storage medium) to facilitate transporting and transferring such methodologies to computers. The term article of manufacture, as used herein, is intended to encompass a computer program accessible from any computer-readable device, carrier, or media, including a non-transitory computer readable storage medium.

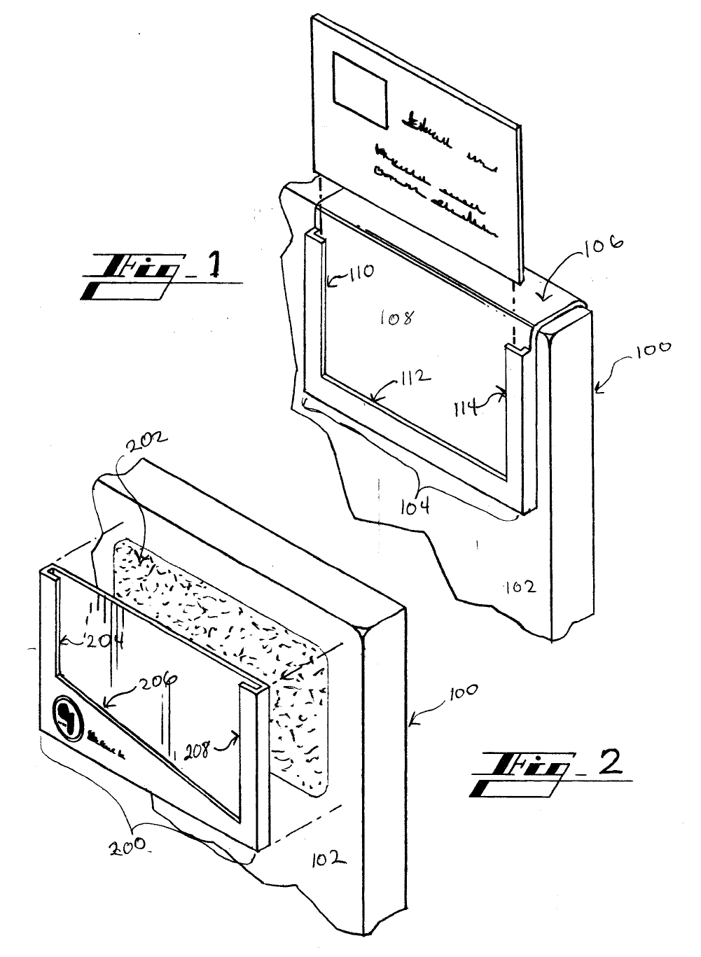

Referring now to FIG. 1, illustrated is a cardholder device with a flange for overlapping a laptop screen perimeter. As a reference point, the laptop screen 100 is where the physical screen resides and what the laptop user views during operation. The laptop screen 100 perimeter is the area that borders the actual laptop screen 100. The rear 102 of the laptop screen 100 is the area that the user does not see during use and would be considered the top of the laptop if the laptop were closed. The cardholder device 104 can comprise a flange 106 for positioning the cardholder device 104 near the top area of the rear 102 of the laptop screen 100. The flange 106 can also be adjustable via an adapter device to facilitate the stability of the flange 106 when it is on the laptop. For instance, if the flange 106 is wider than the laptop screen width, an adapter that can fit inside the flange 106 can have an external surface so dimensioned to fit flush within the flange 106 area and an internal flange that is so dimensioned to fit flush over the rear 102 of the laptop screen 100 and the perimeter of the laptop screen 100. It should be noted that any embodiments herein can be so dimensioned so as not to obstruct the viewing area of the laptop screen 100. Therefore, the flange 106 can be in contact with the laptop screen 100 perimeter while not obstructing the view of the laptop screen 100 itself.

A cardholder area 108 of the cardholder device 104 can comprise a planar surface wherein a rear surface of the planar surface is adjacent to the rear 102 of the laptop screen 100, and a front surface of the planar surface comprises one or more lips for holding a card(s). As shown in FIG. 1, the cardholder device 104 can comprise a left lip 110, a bottom lip 112, and a right lip 114. Although not depicted in FIG. 1, the cardholder device 104 can comprise a top lip, a left lip, and a bottom lip. Additionally, although not depicted in FIG. 1, the cardholder device 104 can also comprise a top lip, a right lip, and a bottom lip. Accordingly, depending upon the aforementioned lip configurations, a card can be inserted into the cardholder accordingly. For instance, in the case where the cardholder device 104 comprises a top lip, a left lip, and a bottom lip, the card(s) can be inserted from right to left. In the case where the cardholder device 104 comprises a left lip, a bottom lip, and a right lip, the card can be inserted from the top to bottom and so on.

It should also be noted that the size and length of the lips can vary. For instance, the left lip 110 can be wider or longer than the right lip 114. The lips can also be linear, ascend, or descend across the cardholder device 104 to form various shapes (i.e.: square, rectangle, triangle, etc.).

Referring now to FIG. 2, illustrated is an adhesive cardholder device 200 utilizing an adhesive 202 to stick to the rear 102 of the laptop screen 100. The adhesive 202 can be used to stabilize the adhesive cardholder device 200 to the rear 102 of the laptop screen 100. The adhesive 202 can comprise a magnet, a permanent adhesive, a removable adhesive, a temperature responsive adhesive, etc. Furthermore, the adhesive cardholder device 200 lips can also be shortened, widened, ascend, descend, and/or thickened to provide support for the cards. For example, FIG. 2 depicts the adhesive cardholder device 200 comprising a bottom lip 206 that descends in height from left to right. Consequently, the lips 204, 206, 208 can be formed to provide additional space for information and/or marketing. The lip 204, 206, 208 can also be formed to provide enough space for a company logo, a business name, a website etc. on the cardholder itself, separate from the actual card. As shown in FIG. 2, although the bottom lip 206 descends in height from left to right, there can be enough space near the leftmost side of the bottom lip 206 to provide logo information.

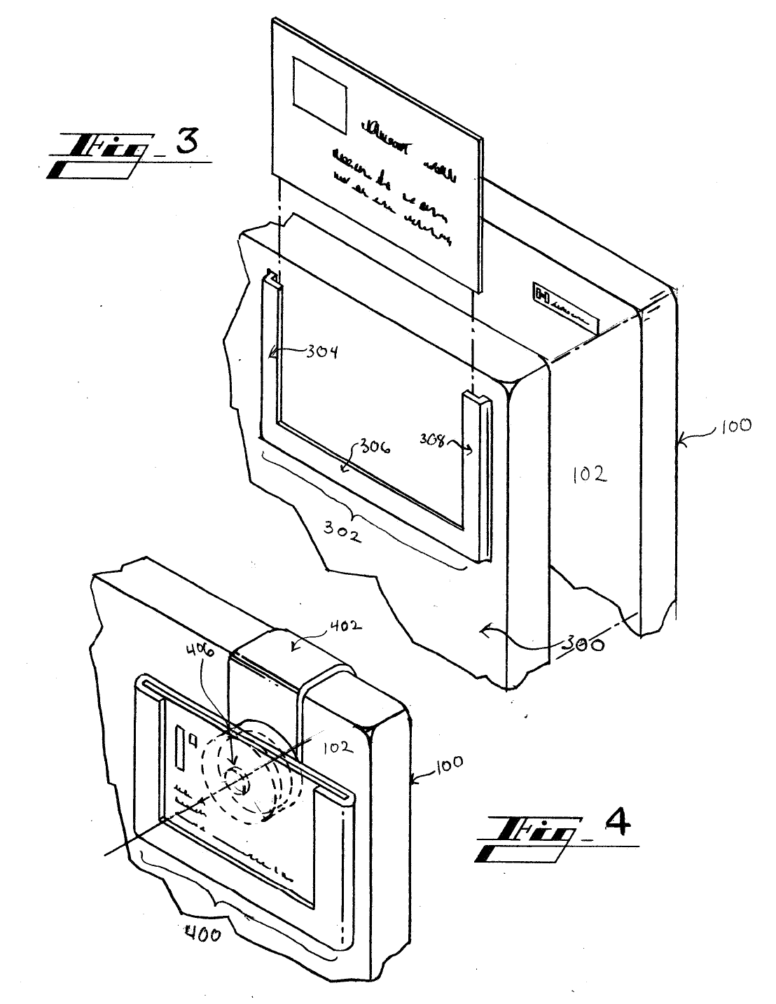

Referring now to FIG. 3, illustrated is a laptop cover comprising a built-in cardholder. The cardholder 302 can be integrated into a laptop cover 300 allowing the cards to be visible to others while the laptop is in use. As shown, the cardholder 302 can comprise a left lip 304, a bottom lip 306, and a right lip 308. However, in other embodiments, the laptop cover 300 cardholder 302 can comprise a right lip 308, a bottom lip 306, and a left lip 304; a top lip (not shown), a left lip 304, and a bottom lip 306; and/or a top lip (not shown), a right lip 308, and a bottom lip 306. The laptop cover 300 lips can be injection-molded lips to facilitate the display of cards. The laptop cover 300 can be made out of any material including, but not limited to, metal, plastic, wood, etc. The laptop cover 300 can attach to the rear 102 of the laptop screen 100 via a variety of means including, but not limited to: form fitting, snaps, form-fitting snaps, adhesive, magnetic, Velcro, etc.

Referring now to FIG. 4, illustrated is an example rotatable cardholder device comprising a cardholder 400, a clip 402, and a grommet 406. The rotatable cardholder device can be integrated with a clip 402, the cardholder 400, and a grommet 406 to form one piece. Alternatively, the cardholder 400, the clip 402, and the grommet 406 can be separate detachable pieces. The grommet 406 can facilitate a 360-degree rotation of the cardholder 400 in respect to the clip 402. The grommet 406 can also interact with or comprise an interlocking mechanism to allow the cardholder 400 to be interlocked (stationary) at varying degrees within the 360 degree rotation. For instance, the interlocking mechanism can be used to facilitate visibility of cards at a 90-degree angle from the clip 402. The cardholder 400 can comprise a right lip, a bottom lip, and a left lip; a top lip, a left lip, and a bottom lip; or a top lip, a right lip, and a bottom lip to facilitate the holding of cards.

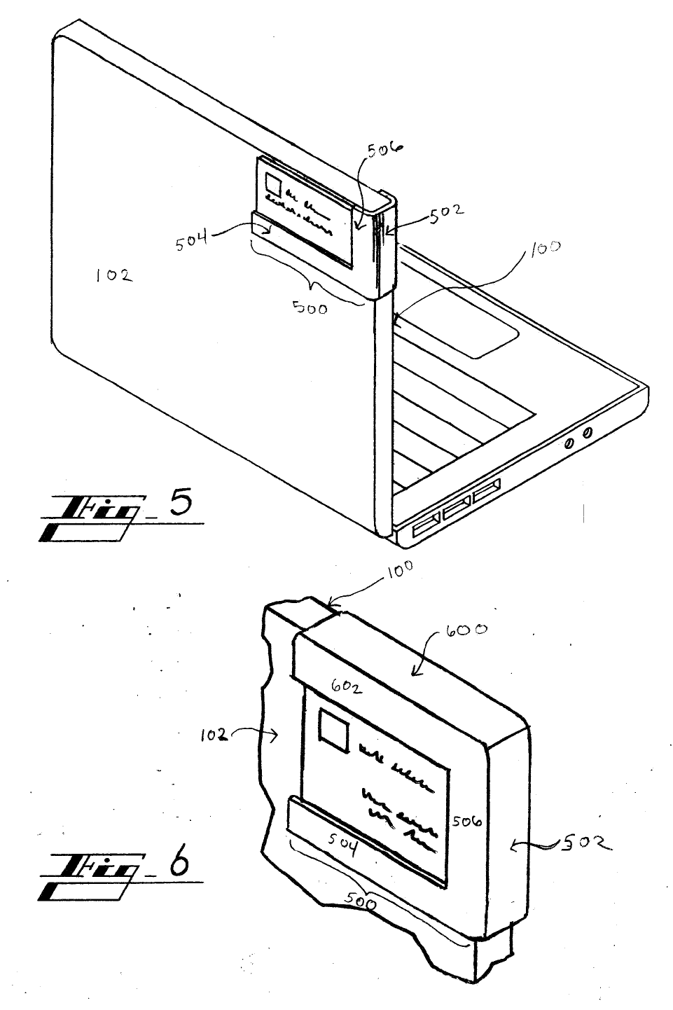

Referring now to FIG. 5, illustrated is an example flange-based cardholder device 500 comprising a right lip 506 and a bottom lip 504. The flange-based cardholder device 500 can comprise a side flange 502 to clip onto the inside laptop screen 100 perimeter of the laptop screen and the rear 102 of the laptop screen 100, wherein the side flange 502 is in contact with the side of the laptop screen 100, also forms the right lip 506. This can facilitate placement of cards within the flange-based cardholder device 500 on the rear 102 of the laptop screen 100. The bottom lip 504 of the flange-based cardholder device 500 can also facilitate placement of the cards.

Referring now to FIG. 6, illustrated is another embodiment of the flange-based cardholder device 500 comprising a top flange 600, a top lip 602, a right lip 506, a bottom lip 504, and the side flange 502. The flange-based cardholder device 500 can comprise a side flange 502 and a top flange 600 to clip onto the laptop screen 100 perimeter of the laptop and the rear 102 of the laptop screen 100, wherein the side flange 502 is in contact with the side of the laptop screen 100, and the top flange 600 is in contact with the top of the laptop screen 100. The side flange 502 and the top flange 600 can also form the right lip 506 and the top lip 602 respectively.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding FIGs, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A cardholder apparatus, comprising:
a prong so dimensioned to fasten to a laptop device; and
a planar surface wherein a rear surface of the planar surface is adjacent to the laptop device, and wherein a front surface of the planar surface comprises a lip for holding a card.

2. The apparatus of claim 1, wherein the lip is a bottom lip and wherein the planar surface comprises a left lip and a right lip.

3. The apparatus of claim 2, wherein the bottom lip descends from right to left.

4. The apparatus of claim 2, wherein the bottom lip descends from left to right.

5. The apparatus of claim 2, wherein the left lip is wider than the right lip.

6. The apparatus of claim 1, wherein the lip is a bottom lip and wherein the planar surface comprises a left lip.

7. The apparatus of claim 1, wherein the lip is a bottom lip and wherein the planar surface comprises a right lip.

8. The apparatus of claim 1, wherein the rear surface of the planar surface comprises an adhesive.

9. A cardholder apparatus, comprising:
a flange so dimensioned to fasten to a laptop device;
a rotating mechanism;
a planar surface, connected to the rotating mechanism, wherein a front surface of the planar surface comprises a lip for holding a card.

10. The apparatus of claim 9, wherein the lip is a bottom lip and wherein the planar surface comprises a left lip and a right lip.

11. The apparatus of claim 10, wherein a height of the bottom lip decreases from right to left.

12. The apparatus of claim 10, wherein a height of the bottom lip increases from right to left.

13. The apparatus of claim 10, wherein the left lip is wider than the right lip.

14. The apparatus of claim 9, wherein the lip is a bottom lip and wherein the planar surface comprises a left lip.

15. The apparatus of claim 9, wherein the lip is a bottom lip and wherein the planar surface comprises a right lip.

16. A cardholder apparatus integrated into a mobile device cover, comprising:
a planar surface of the mobile device cover;
a left lip;
a bottom lip; and
a right lip, wherein the left lip, the bottom lip, and the right lip are so dimensioned to hold a card.

17. The cardholder apparatus of claim 16, wherein the bottom lip ascends from left to right.

17. The cardholder apparatus of claim 16, wherein the bottom lip ascends from right to left.

18. The cardholder apparatus of claim 16, wherein the right lip is wider than the left lip.

19. The cardholder apparatus of claim 16, wherein the left lip is wider than the right lip.

20. The cardholder apparatus of claim 16, wherein the left lip, the bottom lip, and the right lip are located within an upper right quadrant of the mobile device cover.
